(19) United States
(12) Patent Application Publication
(10) Pub. No.: US 2026/0260550 A1
(43) Pub. Date: Sep. 3, 2026

(54) WIRELESS SECURITY DEVICE WITH VISUAL ALERT

(71) Applicant: Carl Thomas Herakovich, Raleigh, NC (US)

(72) Inventor: Carl Thomas Herakovich, Raleigh, NC (US)

(21) Appl. No.: 19/365,851

(22) Filed: Oct. 22, 2025

Related U.S. Application Data
(63) Continuation-in-part of application No. 19/067,887, filed on Mar. 1, 2025, now abandoned.

(51) Int. Cl. G08B 5/36; G08B 25/10; G08B 21/18

(52) U.S. Cl. CPC G08B 5/36; G08B 25/10; G08B 21/18

(57) ABSTRACT

The present invention relates to a device, either mountable or portable, which indicates the alarm status e.g. on off or standby of a security alarm system, while the user is inside the house or outside the house especially if the user wishes to exit a door that the control panel is not near or has forgotten if the alarm is set when reentering the house.

This application is a continuation in part of US non-provisional application number 19/067,887 filed Mar. 1, 2025, and is incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a security system status indicator. More particularly, it relates to a remote status indicator that can be used anywhere the main security system panel is not located.

### Description of Related Art

Security alarm systems, especially in home situations, typically have one or more control panels near exit doors or windows. Frequently, there is not a control panel at every exit. Rather, control panels are typically located at the exit doors that are most frequently used. Exiting the doors with no control panels can accidently trip the alarm. In addition, after leaving the house there is no way of knowing if the house alarm has been activated. This can also cause accidental tripping of the alarm system.

### BRIEF SUMMARY OF THE INVENTION

The present invention relates to a device, either mountable or portable, which indicates the alarm status e.g. on, off or standby, while the user is inside the house or outside the house especially if the user wishes to exit a door that the control panel is not near or has forgotten if the alarm is set when reentering the house. Because the device has a single function, it can be made relatively small and unobtrusive.
a) a wireless receiver for receiving a status signal from a security system;
b) a computer for taking the status signal from the wireless receiver and delivering it to a visual indicator;
c) the visual indicator for indicating the security system status; and
d) a battery.

### BRIEF DESCRIPTION OF THE DRAWINGS

FIG. 1 is a schematic of the wireless indicator device being used with a security system.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms "a" or "an", as used herein, are defined as one or as more than one. The term "plurality", as used herein, is defined as two or as more than two. The term "another", as used herein, is defined as at least a second or more. The terms "including" and/or "having", as used herein, are defined as comprising (i.e., open language). The term "coupled", as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to "one embodiment", "certain embodiments", “an embodiment", or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term "or", as used herein, is to be interpreted as an inclusive or meaning any one or any combination. Therefore, "A, B, or C" means any of the following: "A; B; C; A and B; A and C; B and C; A, B, and C". An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “visual indicator” refers to a light (such as an LED) or other visual indicator of the status of the security system. It could be one for on or off or individual lights for on, off or other status like standby.

As used herein, the term “security system status” refers to whether a security alarm is activated or not. When this information is transmitted to the device of the invention, the device can be used to determine the security alarm status without going to the main panel of the security system. The sole function is to prevent accidentally engaging the alarm when leaving a door or entering a door.

As used herein, the term “wireless receiver” refers to the device of the invention having a receiver designed to receive a wireless status signal from a security alarm system.

As used herein, the term “status signal” refers to a signal from an alarm system which discloses if the alarm system is off or activated so a user can open doors without checking the main security system panel itself.

As used herein, the term “computer” refers to a device like a micro controller, raspberry or the like that can fit in the device of the invention which can receive the status condition from the wireless receiver and initiate the appropriate visual indicators regarding the alarm status.

As used herein, the term “wireless status indicator” refers to a device which receives a wireless signal (Bluetooth or other wireless method and the like) from a security alarm system. It then sends data of the status to a computer which initiates a visual indicator of the status for a user to see. The device is powered by a battery and in one embodiment it is portable. In another embodiment it is attached to a surface.

As used herein, the term “battery” refers to an independent wireless AC or DC power source designed to power the device. It can be a rechargeable source, or in one embodiment it has an exchangeable power source e.g. Li-ion battery.

### DRAWINGS

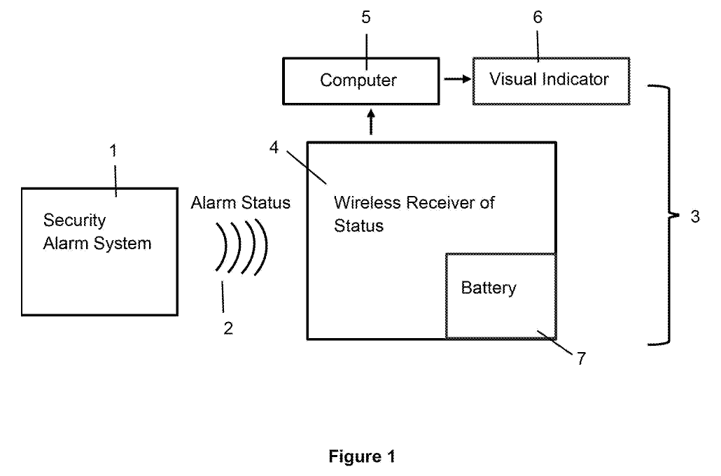

Now referring to the drawings, FIG. 1 is a schematic of the wireless indicator device being used with a security system. Security system alarm 1 sends a wireless status of the alarm system 2. It is received by the device of the invention 3. The device has wireless receiver 4 for the security system status, the data is sent to computer 5 which initiates a visual indicator 6. The device 3 is powered by battery 7.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A wireless indicator device for a security system on, off, or standby status consisting of:
a) a wireless receiver for receiving an on, off, or standby status signal from a home security system;
b) wherein the wireless receiver delivers the on, off, or standby status to a visual indicator on the wireless indicator device;
c) a battery.

2. The wireless indicator according to claim 1 wherein the battery is rechargeable.

3. The wireless indicator according to claim 1 wherein the visual indicator is one or more lights.

4. (canceled)

5. (canceled)

6. (canceled)
